(19) United States
(12) Patent Application Publication
(10) Pub. No.: US 2007/0178950 A1
(43) Pub. Date: Aug. 2, 2007

(54) Wearable multimodal computing device with hands-free push to talk

(75) Inventors: James R. Lewis, Delray Beach, FL (US); Leslie R. Wilson, Boca Raton, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/334,838

(22) Filed: Jan. 19, 2006

(51) Int. Cl. H04M 1/00

(52) U.S. Cl. 455/575.6

(57) ABSTRACT

A wearable computing system can comprise a device attachment mechanism and a push to talk actuator. The device attachment mechanism can include a device coupler and a body affixer. The device coupler can detachably couple a portable computing device to the device attachment mechanism. The body affixer can detachably affix the device attachment mechanism to a forearm of a user positioned between a wrist of the user and an elbow of the user. The push to talk actuator can be activated by the user utilizing at least one of an arm, a hand, a wrist, and a finger movement. The push to talk actuator can be coupled to an actuator attachment mechanism that is wearably attached to the user in a hands-free fashion.

### BACKGROUND

1. Field of the Invention

The present invention relates to the field of mobile computing ergonomics and, more particularly, to wearable multimodal computing devices with hands-free push to talk functionality.

2. Description of the Related Art

Multimodal user interfaces utilize more than one interface modality for input/output, such as a visual modality and a speech modality. Multimodal interfaces are extremely popular for mobile computing devices or embedded devices that often have limited peripheral devices. That is, devices such as mobile telephones, personal data assistants, mobile entertainment devices, tablet computers, navigation devices, and the like often have a tiny screen and limited input mechanisms, which are supplemented or replaced by speech input/output mechanisms.

Many multimodal devices that accept speech input utilize a push to talk button that initializes audio input and enables a speech recognition engine. A second selection of the push to talk button can halt speech input and speech recognition processes. Not all arrangements of multimodal devices that include a push to talk button require the second selection of a push to talk button to disable audio input. Instead, it is common for audio input to be automatically disabled after a designated period of relative silence.

Traditional push to talk buttons are ergonomically problematic. Specially, a push to talk button is typically included on the multimodal device itself, such as on the front or a side of the device. The multimodal device is typical designed to be held in one or both hands, with the push to talk button being designed to be activated with a thumb movement (like a handheld two-way radio talk switch) or with the hand not holding the multimodal device. This arrangement makes it impossible for the multimodal device to be utilized in a hands-free fashion. In other words, a user's hands are constrained to holding the multimodal device and/or selecting a push to talk button, which can constrain the utility of the multimodal device to situations where at least one of user's hands are free to control the device.

Other problems with traditional design of multimodal devices that include a push to talk button exist that make using the push to talk button difficult. For example, mobile computing devices are often relatively wide devices (wider than handheld two-way radios) that makes repetitively using a side button designed for thumb activation a difficult and fatiguing task. In another example, mobile computing device buttons are typically small due to space constraints, which make accurate selection of these buttons difficult. The difficulty is increased in situations where a user is operating and holding the device with a single hand while simultaneously attempting to perform a task not related to the device.

Further, positioning of features and components of the multimodal device relative to the push to talk button can make the operation of the device difficult. For instance, the placement of the push to talk button can cause a user's hand to inadvertently cover a device microphone preventing the device from properly receiving speech input.

### SUMMARY OF THE INVENTION

A solution that permits a multimodal computing device with a push to talk button to be operated in a hands-free fashion is disclosed herein. In one embodiment, the solution provides a wearable forearm strap to which a computing device can be affixed. For example, the forearm strap can include a hook and loop fastener and/or a swivel mount. A corresponding fastener can be coupled to the multimodal computing device so that the device can be detachably coupled to the forearm strap. The forearm strap and fasteners can be arranged so that a display screen can be viewed by a user to which the device is attached. Additionally, the strap can be fashioned so that it is wearable upon either a right or left forearm in a manner that permits a user's hands to remain unencumbered.

A wired or wireless port of the device can be connected to a detached push to talk button, which can also be worn and/or utilized in a hands-free fashion. For example, a hand strap including a palm squeeze push to talk button can be worn around a user's palm. Selection of the push to talk button can cause the multimodal computing device to accept audio input and/or to speech recognize received speech.

The present invention can be implemented in accordance with numerous aspects consistent with material presented herein. For example, one aspect of the present invention can include a wearable computing system. The system can comprise a device attachment mechanism and a push to talk actuator. The device attachment mechanism can include a device coupler and a body affixer. The device coupler can detachably couple a portable computing device to the device attachment mechanism. The push to talk actuator can be activated by the user utilizing at least one voluntary muscle movement. The push to talk actuator can be coupled to an actuator attachment mechanism that is wearably attached to the user in a hands-free fashion.

Another aspect of the present invention includes a multimodal computing system with a wearable push to talk actuator. The system can include at least one activation sensor, an actuator attachment mechanism, and a communicator. The actuator attachment mechanism can couple the push to talk actuator to at least one of an arm, a hand, a wrist, and a finger of a user. The communicator can convey a notifier to a multimodal computing device responsive to a user activation of the activation sensor. The push to talk actuator can be physically separate from the multimodal computing device.

Yet another aspect of the present invention can include a wearable system for a portable multimodal computing device. The system can include a device coupler, a body affixer, and a push to talk actuator. The device coupler can detachably couple a portable multimodal computing device to a device attachment mechanism. The body affixer can detachably affix the device attachment mechanism to a forearm of a user between a wrist of the user and an elbow of the user. A display of the multimodal computing device can be viewable by the user when the device is affixed to the forearm. The push to talk actuator can be remotely located from the portable multimodal computing device. The push to talk actuator can be selectively activated by a user.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a wearable computing system in accordance with an embodiment of the inventive arrangements disclosed herein.

FIG. 2 is a schematic diagram of a multimodal computing device and a device attachment mechanism in accordance with an embodiment of the inventive arrangements disclosed herein.

FIG. 3 is a schematic diagram of a push to talk actuator in accordance with an embodiment of the inventive arrangements disclosed herein.

FIG. 4 is a schematic diagram illustrating a system where a device attachment mechanism and a push to talk actuator are combined in accordance with an embodiment of the inventive arrangements disclosed herein.

### DETAILED DESCRIPTION OF THE INVENTION

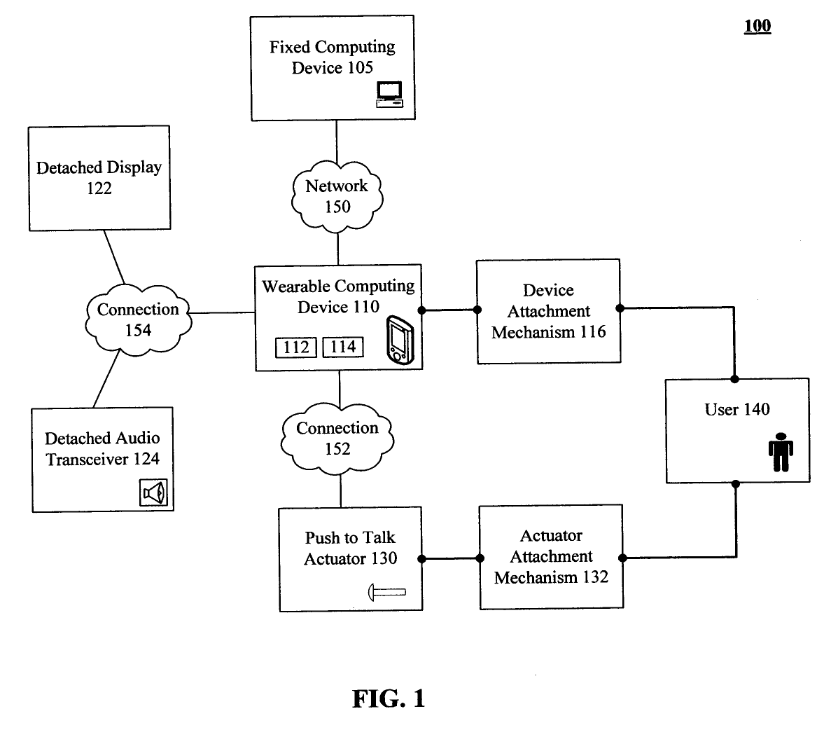

FIG. 1 is a schematic diagram of a wearable computing system 100 in accordance with an embodiment of the inventive arrangements disclosed herein. System 100 includes wearable computing device 110, push to talk actuator 130, and user 140. User 140 can be a human being that wears wearable computing device 110 and/or activates push to talk actuator 130.

Device 110 is a multimodal computing device having at least one speech modality. Device 110 can include a graphical user interface (GUI) and traditional GUI input/output devices, such as a keyboard, mouse, display, and the like. Device 110 can be any of a variety of computing devices including, but not limited to, a computing tablet, a personal computer, a personal data assistant (PDA), a mobile telephone, a media player, an entertainment gaming system, an electronic contact management system, and the like.

Device 110 can be configured to operate in a stand alone fashion. Alternatively, device 110 can be a device that cooperatively participates in a network of distributed computing devices. Device 110 can also be a thin client linked to a fixed computing device 105 via network 150. Network 150 can facilitate data exchanges over wireless as well as line-based communication pathways and protocols.

In one embodiment, device 110 can include display 112 and audio transceiver 114 both of which are components of device 110. Audio transceiver 114 can include a microphone for accepting audio input and a speaker for producing audio output. The audio input can include speech that is speech-to-text converted using a speech-to-text processing engine. The audio output can be generated from prerecorded sound and speech files as well as generated from text converted by into speech by a text-to-speech processing engine. The text-to-speech and speech-to-text engines can be embedded within the device 110 and/or remotely located from but communicatively linked to device 110.

Display 112 can be used to visually present textual and graphical output. In one contemplated configuration, display 112 can include a touch screen or touchpad mechanism that accepts user input. Display 112 can be constructed using any of a variety of technologies including, but not limited to, liquid crystal display (LCD) technologies, organic light emitting diode (OLED) technologies, and E-INK technologies.

Additionally, device 110 can include one or more ports for peripheral devices. The ports can include wired ports as well as wireless transceiver components. Using these ports, device 110 can be linked to detached display 122 and/or detached audio transceiver 124 via connection 154. Detached display 122 and/or audio transceiver 124 can be used in addition to or in replacement of display 112 and/or transceiver 114. For example, audio transceiver 124 can include an ear bud speaker and a microphone headset that user 140 can wear on or about his/her head, which when enabled can replace embedded transceiver 114. In another example, display 122 can include a display presented within glasses worn by user 140 or can include an external monitor within easy view of user 140.

In one embodiment, the wearable computing device 110 can be selectively coupled to device attachment mechanism 116, which can be in turn attached to user 140. The device attachment mechanism 116 can be configured in an unobtrusive fashion so that device 110 can be worn in a hands-free fashion. As used herein, a hands-free fashion can mean that the device 110 can be worn and/or utilized by user 140 without encumbering the hands and movement of user 140.

It should be appreciated that the device 110 can be specifically designed to be worn by user 140, in which case a separate device attachment mechanism 116 can be unnecessary. Alternatively, device 110 can be designed for handheld operation and attachment mechanism 116 can represent a post design retrofit that permits device 110 to be worn by user 140.

One contemplated location for the device attachment mechanism 116 to be worn is upon the inner forearm of user 140, with the device 110 attached to the device attachment mechanism so that display 112 can be easily viewed by user 140. Other configurations are contemplated, such as a hip or belt attachment position, and the invention is not to be construed as limited in this regard.

Push to talk actuator 130 can include an activation mechanism, which user 140 can selectively enable. The activation mechanism can include a tactile switch or button that responds to pressure. The activation mechanism can also include an electromyographic sensor that utilizes skin electrodes to detect specific muscle patterns that user 140 can voluntarily control. For example, an electromyographic sensor can be triggered by user 140 touching a thumb and little finger. The activation mechanism is not to be limited to any particular technology and any of a variety of other sensor and switching technologies are contemplated herein. For example, pneumatic, hydraulic, temperature, audio, eye tracking, and combinations thereof are contemplated.

The push to talk actuator 130 can be connected to an actuator attachment mechanism 132, which is in turn attached to user 140. For example, the actuator attachment mechanism 132 can include a hand strap worn around a hand of user 140. The user selectable actuator 130, such as a palm squeeze actuator or a bump to talk actuator, can be attached to the strap worn about the hand. The actuator attachment mechanism 132 can be configured so that the actuator 132 can be worn by user 140 in a hands-free fashion.

It should be appreciated that the actuator attachment mechanism 132 is not to be limited to a hand strap arrangement, but can be implemented in any of a variety of other manners. For example, the actuator attachment mechanism 132 can include a hat having a forehead muscle actuator 130 that can be worn on a user's head. In another example, the actuator attachment mechanism 132 can include a shoe having an actuator 130 configured to be activated by foot or toe movements. Mechanism 132 can include any attachment means to a human body and actuator 130 can be actuated by any voluntary muscle movement of user 140.

Push to talk actuator 130 can be communicatively linked to device 110 via connection 152. Connection 152 can include a wireless connection, such as a BLUETOOTH connection. Connection 152 can also include a line-based connection, such as a USB connection established between compatible ports of actuator 130 and device 110.

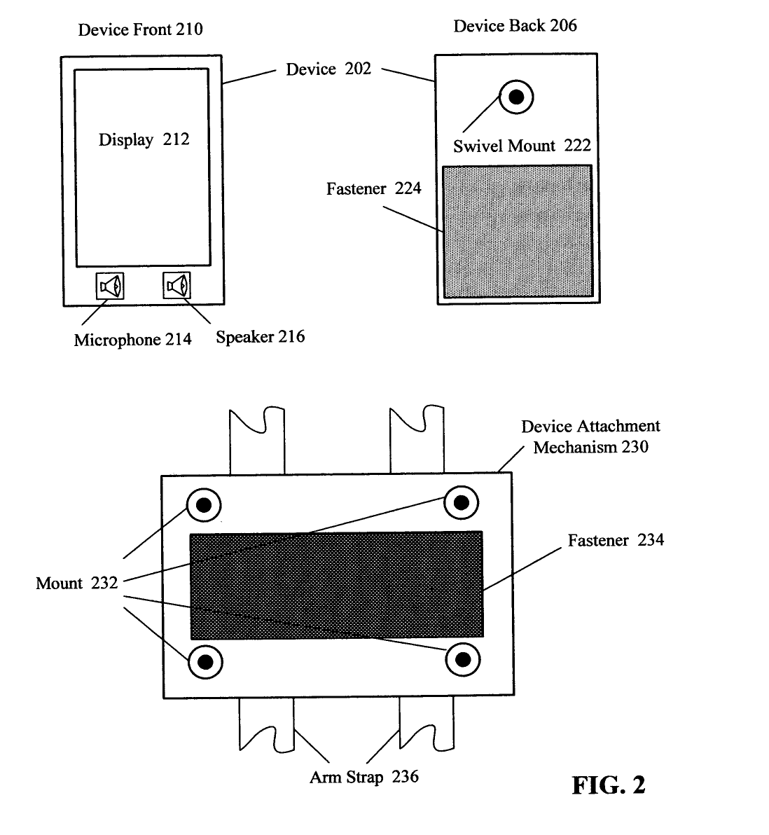

FIG. 2 is a schematic diagram of a multimodal computing device 202 and a device attachment mechanism 230 in accordance with an embodiment of the inventive arrangements disclosed herein. Two views, a device front 210 view and a device back 206 view are illustrated in FIG. 2.

The Device front 210 can include a display 212, a microphone 214, and a speaker 216. The display 212 can be configured to be viewed vertically in a portrait mode and to be viewed horizontally in a landscape mode. It should be appreciated that although microphone 214 and speaker 216 are shown positioned in the device front 210, each can be positioned in different locations of the device 202, such as on any of the device sides or back 206.

The device back 206 can include one or more fasteners that are designed to be coupled to corresponding fasteners of the device attachment mechanism 230. For example, swivel mount 222 can be coupled to any of the mounts 232. Swivel mounts 222 can permit the device 202 to be rotateably attached to the device attachment mechanism 230. The ability to rotate device 202 when attached to the device attachment mechanism 230 permits a user to selectively rotate the device so that the display 212 is more easily viewed in either a portrait mode or a landscape mode.

Fasteners 224 and 234 can be hook and loop fasteners, such as VELCRO, designed to permit the device 202 to be detachably affixed to the device attachment mechanism. In one embodiment, a user can use the combination of swivel mount 222 mated to mount 232 and fastener 224 mated to fastener 234. This combination can more firmly affix the device 202 to mechanism 230 than would be possible with a single fastener or mount. Beneficially, multiple mounts 232 can be included on the device attachment mechanism 230 to permit the mechanism to be worn on either a right or a left forearm of a user depending upon which position is most convenient to the user.

Arm strap 236 can be used to secure the device attachment mechanism 230 to a forearm or other body part of a user. Straps 236 can be constructed of a stretchable fabric that can be slipped over an arm. Alternatively, opposing ends of straps 236 can be tied or cinched together so that the mechanism 230 is firmly affixed to a forearm.

It should be appreciated, that the fasteners 224 and 234, mounts 222 and 232, and straps 236 are presented as one contemplated arrangement of a general concept of a wearable computing device described herein. Any of a variety of other couplers can be utilized other than those shown in FIG. 2. For example, magnetically joined fasteners can be used to affix device 202 to device attachment mechanism 230. Additionally, a transparent enclosure (not shown) can be integrated within the device attachment mechanism 230, within which device 202 can be securely inserted. In yet another example, the backside of mechanism 230 can include a hook and loop fastener (not shown) that can be affixed to a mated hook and loop fastener sewn into a suitable location of a user's clothing.

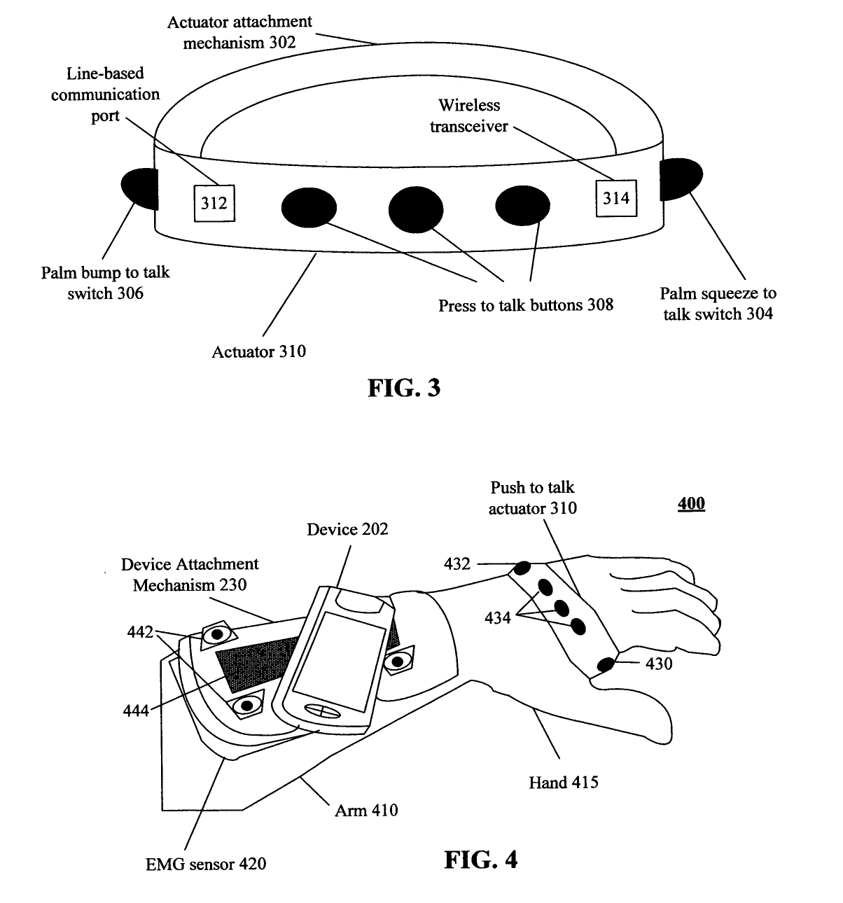

FIG. 3 is a schematic diagram of a push to talk actuator 310 in accordance with an embodiment of the inventive arrangements disclosed herein. Actuator 310 represents one contemplated embodiment for push to talk actuator 130.

The push to talk actuator 130 can include an actuator attachment mechanism 302 that permits the actuator 310 to be worn by a user. As illustrated, mechanism 302 is configured to permit actuator 310 to be worn around a user's hand or palm. Derivative attachment mechanisms 302 configured for different body locations and activation movements are contemplated herein.

For example, in one contemplated embodiment (not illustrated), push to talk activation can be based upon eyeball movements. Relevant eye tracking sensors can be contained within a frame of eyeglasses to be worn by the user. The attachment mechanism in such an embodiment can include the eyeglass frame to be supported by the ears and nose of a user.

The push to talk actuator 310 can include a number of buttons and/or switches that can be selectively activated by a user. These can include, for example, a palm squeeze to talk switch 304 to be positioned between a user's thumb and forefinger when worn. A bump to talk switch 306 can be positioned on the opposite side a user's pinky finger to be activated by bumping the hand against any hard surface, such as a table or wall. One or more press to talk buttons 308 can be positioned on the back of a user's hand to be activated by a user depressing these buttons with digits from the opposing hand.

The actuator 310 can be communicatively linked to a multimodal device in any of a plurality of fashions. For example, a wireless transceiver 314, such as a BLUETOOTH transceiver, can be included in the actuator and used to communicate with a remotely located multimodal device. Similarly a port 312 for line-based communication, such as a USB port, can be included to enable line based communications between the actuator 310 and a linked multimodal device.

It should be appreciated that the activateable sensors shown in FIG. 3 are to illustrate a general concept disclosed herein and that other sensors can be utilized. For example, in one contemplated embodiment (not shown) an electromyographic (EMG) based sensor can be used to trigger a push to talk sensor. The EMG sensor can be positioned to make skin contact, such as being positioned on the inside of push to talk actuator 310. EMG sensors can detect previously configured muscle movements, such as finger touches, wrist twists, and the like. Movements for activation can be combined so that inadvertent activation is unlikely, while still permitting simplistic hands-free activation of a push to talk sensor.

Additionally, although the actuator 310 is shown in FIG. 3 as a separate and detached unit from the device attachment mechanism 230, embodiments consisting of an integrated device are contemplated. For example, an EMG based sensor can be included on the backside of device attachment mechanism 230.

FIG. 4 is a schematic diagram illustrating a system 400 where device attachment mechanism 230 and push to talk actuator 310 are combined in accordance with an embodiment of the inventive arrangements disclosed herein. In system 400 device 202 can be mounted to mechanism 230 worn upon a user's arm 410. Push to talk actuator 310 can be worn around a user's hand 415. Also illustrated in system 400 is optional EMG sensor 420, which can be used in conjunction with or in place of push to talk actuator 310.

Numerous previously discussed features are readily apparent in system 400. These features include palm squeeze to talk switch 430, bump to talk switch 432, and press to talk buttons 434. System 400 also shows how swivel mounts 442 can be combined with hook and loop fastener 444 for easy viewing of device 202 in either a portrait or a landscape mode.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A wearable computing system comprising:
a device attachment mechanism comprising a device coupler and a body affixer, wherein said device coupler is configured to detachably couple a portable computing device to the device attachment mechanism, and wherein the body affixer is configured to detachably affix the device attachment mechanism to a user, wherein the device attachment mechanism is configured so that when the device coupler is coupled to the portable computing device and when the body affixer is affixed to the user; and
a push to talk actuator configured to be activated by the user utilizing a voluntary muscle movement, the push to talk actuator is coupled to an actuator attachment mechanism, wherein the actuator attachment mechanism is configured to be wearably attached to the user in a hands-free fashion.

2. The system of claim 1, further comprising:
the portable computing device coupled to the device coupler, wherein said portable computing device is a multimodal device having a speech modality and a visual modality, wherein a user selection of the said push to talk actuator responsively causes the portable computing device to enter a speech input mode.

3. The system of claim 2, wherein the portable computing device comprises an embedded display for visually presenting output, wherein the embedded display is configured to be viewed by the user having the portable computing device wearably attached to a forearm of the user.

4. The system of claim 3, wherein the device attachment mechanism is configured to permit the user to selectively adjust a position of the portable computing device in a device rotateable fashion, which permits the user to orient the embedded display for optimal viewing for a landscape viewing mode and for a portrait viewing mode.

5. The system of claim 1, wherein the device coupler comprises a hook and loop fastener.

6. The system of claim 1, wherein the device coupler comprises a swivel mount.

7. The system of claim 1, wherein the push to talk actuator is communicatively linked to the portable computing device via a wireless communication link.

8. The system of claim 7, wherein the push to talk actuator is physically separate from the device attachment mechanism, whereby the push to talk actuator is not physically attached to the device attachment mechanism.

9. The system of claim 1, wherein the push to talk actuator is configured to be strapped around a hand of the user, and wherein the body affixer is configured to be attached to a forearm of the user so that the portable computing device is positioned between a wrist of the user and an elbow of the user and remains attached in a hands-free fashion.

10. A multimodal computing system with a wearable push to talk actuator comprising:
at least one activation sensor;
an actuator attachment mechanism configured to couple the push to talk actuator to at least one of an arm, a hand, a wrist, a forehead, and a finger of a user; and
a communicator configured to convey a notifier to a multimodal computing device responsive to a user activation of the activation sensor, wherein the push to talk actuator is physically separate from the multimodal computing device.

11. The system of claim 10, further comprising:
a device attachment mechanism configured to be worn on a user's forearm to which the multimodal computing device is affixed.

12. The system of claim 11, wherein the device attachment mechanism affixes the multimodal computing device using a hook and loop fastener and a swivel mount.

13. The system of claim 10, wherein the at least one activation sensor includes an electromyographics based sensor.

14. The system of claim 10, further comprising:
a device attachment mechanism configured to be worn on a user's forearm to which the multimodal computing device is affixed, wherein the at least one activation sensor includes an electromyographics based sensor configured to be positioned between a users arm and the device attachment mechanism.

15. The system of claim 10, wherein the at least one activation sensor includes a palm squeeze sensor that detects an activation of a palm squeeze switch.

16. The system of claim 10, wherein the at least one activation sensor includes a palm bump sensor that detects an activation of a bump to talk switch configured to be worn on a side of a user's palm.

17. The system of claim 10, further comprising:
a wireless transceiver configured to wireless convey the notifier from the push to talk actuator to the multimodal device.

18. A wearable system for a portable multimodal computing device comprising:
a device coupler configured to detachably couple a portable multimodal computing device to a device attachment mechanism,
a body affixer configured to detachably affix the device attachment mechanism to a forearm of a user between a wrist of the user and an elbow of the user, wherein when attached a display of the multimodal computing device is viewable by the user; and
a push to talk actuator remotely located from the portable multimodal computing device configured to be selectively activated by a user.

19. The wearable system of claim 18, wherein the device coupler comprises a swivel mount and a hook and loop fastener.

20. The wearable system of claim 18, wherein the body affixer comprises a plurality of different device mounts, wherein different ones of the device mounts are utilized to secure the multimodal computing device, wherein the utilized ones of the device mounts depends upon whether the body affixer is worn on a right forearm or a left forearm of the user.
